(19) United States
(12) Patent Application Publication
(10) Pub. No.: US 2006/0164328 A1
(43) Pub. Date: Jul. 27, 2006

(54) Method and apparatus for wireless display monitor

(75) Inventor: Kosar A. Jaff, Kirkland, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/041,411

(22) Filed: Jan. 24, 2005

(51) Int. Cl. G09G 5/00

(52) U.S. Cl. 345/2.3

(57) ABSTRACT

Systems and methods that facilitate wireless display via employing a frame buffer encoder and a wireless transmission as part of a graphics card of a computing device. The encoder can encode a scheme programmable in software to detect type of format the receiving monitor is capable of displaying. The wireless transmission can occur in a variety of formats; such as Ultra Wide Band (UWB), Internet Protocol (IP) data packets, and the like.

### TECHNICAL FIELD

The subject invention relates generally to wireless monitors, and in particular to employing an encoder as part of the graphics card to compress frame buffer directly, and send data wirelessly to a display in form of a compressed stream.

### BACKGROUND OF THE INVENTION

Increasing advances in computer technology (e.g., microprocessor speed, memory capacity, data transfer bandwidth, software functionality, and the like) have generally contributed to increased computer application in various industries. Ever more powerful server systems, which are often configured as an array of servers, are often provided to service requests originating from external sources such as the World Wide Web, for example.

Moreover, today a variety of input and output devices for video signal transferring are widely used in personal computers (PCs), projectors, video recorders, and laser compact disc players, and the like. The video information of a PC is transferring to a display (for example a monitor) by means of an interface. The interface can be a monochrome display adapter (MDA), a color graphic adapter (CGA), a video graphic array (VGA), or a more advanced super VGA (SVGA). In general, VGA is in widely use among all kinds of video adapter in that it has a high level of compatibility. A generic VGA can have fifteen pins, wherein each pin in general can have a definition associated therewith, except for three spare pins. For example, the fourth pin can be associated with transferring blue color signals, the ninth pin can be defined as for transferring red color signals, and the fourteenth pin is defined as for transferring vertical sync signals.

Also, Digital Visual Interface (DVI) cables are commonly employed to connect the computer to the display. In general, DVI is a digital interface standard created by the Digital Display Working Group (DDWG) to convert analog signals into digital signals to accommodate both analog and digital monitors. Data is transmitted using the transition minimized differential signaling (TMDS) protocol, providing a digital signal from the PC's graphics subsystem to the display. The standard specifies a single plug and connector that encompass both the new digital and legacy VGA interfaces, as well as a digital-only plug connector. DVI can handle bandwidths in excess of 160 MHz and thus supports Ultra Extended Graphics Array (UXGA) and High-Definition Television (HDTV) with a single set of links. Higher resolutions can be supported with a dual set of links.

At the same time, there is a tendency to eliminate inconveniences created by connecting cables to display devices. For example, in typical PC arrangement, the video monitor is a separate external unit to the PC, which typically contains the PC motherboard on which are mounted the microprocessor and associated memory, BIOS and control circuits. The external video monitor unit is typically connected to the PC motherboard or graphics adapter by means of a cable that is connected at one of its ends, to the video socket on the motherboard or graphics adapter; the other end of the cable extends external from the PC and is plugged into the video input of the monitor. Such cables can cause wire clutter and take up work space when implementing the system.

Also, from an aesthetic stand point cables can be unsightly. For example, a visible cable on, or underneath a corporate conference table constitutes both aesthetic and practical negatives, whereas the wireless devices' “no wires” effect enhances both professionalism and dignity of the surroundings. Similarly, in a home setting, PCs have been migrating from home offices into family rooms and living rooms, and may well be the platform of choice for the home entertainment center. Such migration makes 'net-surfing, game-playing, and running standard PC applications available to families in the same setting in which the view television. In addition, the wires or cables can further present safety hazards, for example in form of entanglements, or trip and fall incidents. Accordingly, wires and cables associated with monitors can be problematic, and fail to complement other associated wireless equipment such as wireless keyboards and the like.

Therefore, there is a need to overcome the aforementioned exemplary deficiencies associated with conventional systems and devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods that facilitate wireless display via employing a frame buffer encoder and a wireless transmission as part of a graphics card of a computing device. The encoder can encode a scheme programmable in software to detect type of format the receiving monitor is capable of displaying. Accordingly, the monitor can be a general purpose viewing equipment, and typically need not carry a burden of reproducing Graphical Design Interface (GDI) subsystem as a part thereof, and hence can mitigate a price increase associated with the monitor. For example, according to an aspect of the invention a simple decoder as part of the monitor can decode a data stream transmitted thereto via the transmitter of the graphics card.

In a related aspect of the subject invention, the computing device can perform conversion from high level semantics transformation to graphics data, (e.g., during establishment of a remote connection), which can then be forwarded to the frame buffer. Such frame buffer can be time-based, to be updated at regular intervals (e.g., 60-90 frames per second) to produce a rich animation experience. For example, similar to placing data in a frame buffer for purpose of transferring to an analog/digital converter, the subject invention can interact with the frame buffer, yet instead of converting digital to analog signals to drive the monitor, the subject invention supplies a compressed wireless data stream to the monitor. Such system can typically take full advantage of hardware available on the hardware of the computing device, and the Graphical Processing Unit (GPU).

According to a further aspect of the subject invention, the encoder of the graphics card can read from the frame buffer and provide a light weight encoding or compression scheme for transmission to the monitor, while at the same time the Graphical Processing Unit (GPU) can write to the frame buffer. In the context of terminal services that run on computers, for example, the subject invention can control data being sent to the monitor, (e.g., wirelessly transmit images for a particular window, or images of the entire desk top), rather than employing GDI commands, which must be decoded and then replicated on the monitor. The wireless data transfer can occur in a variety of formats; such as Ultra Wide Band (UWB) running USB protocol, Internet Protocol (IP) data packets running over WiFi (IEEE 802.11 g), and the like. The decoder can also be part of the monitor or a separate component operatively connected thereto.

According to a methodology of the subject invention, a display format for the monitor can be initially determined. Hence, data to be transferred wirelessly can be encoded such that it can be properly decoded and displayed at the monitor side. The CPU can write to the GPU and into the frame buffer. By eliminating the VGA and/or DVI cable, data in the frame buffer can be encoded and transmitted as a compressed stream (e.g., 60-80 mega bytes per second). Such data stream can be decompressed at the monitor side and displayed. The monitor can also operate via a fuel cell as to eliminate the power cable associated therewith.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a block diagram of a wireless system according to one aspect of the subject invention.

FIG. 2 illustrates a block diagram of a graphics card according to one particular aspect of the subject invention.

FIG. 3 illustrates a general architecture for a computing device that incorporates an aspect of the subject invention.

FIG. 4 illustrates a methodology of wireless display in accordance with an aspect of the subject invention.

FIG. 5 illustrates a further block diagram of a wireless display system in accordance with an aspect of the subject invention.

FIG. 6 illustrates a methodology of wireless display according to further aspect of the subject invention.

FIG. 7 illustrates a prior art system arrangement during establishment of a remote session.

FIG. 8 illustrates a system arrangement for a wireless monitor during establishment of a remote session and terminal services according to an aspect of the subject invention.

FIG. 9 illustrates a brief, general description of a suitable computing environment is wherein the various aspects of the subject invention can be implemented.

FIG. 10 illustrates a client-server system that can incorporate various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

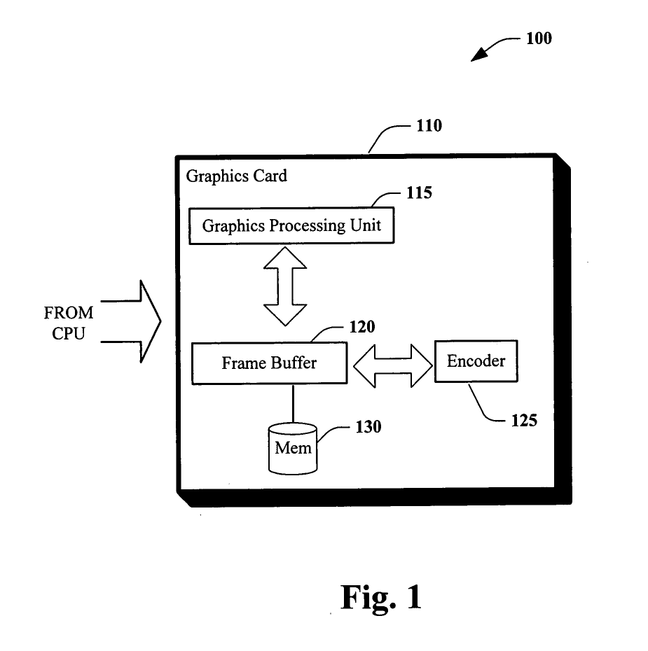

The subject invention provides for systems and methods for a wireless display monitor via employing a frame buffer encoder and a wireless transmission as part of a graphics card of a computing device. Referring initially to FIG. 1, a block diagram of a wireless system 100 according to a particular aspect of the subject invention is illustrated. The system includes a graphic card 110 with a Graphics Processing Unit (GPU) 115 that can be operatively connected to a Central Processing Unit (CPU) (not shown). The GPU 115 can receive an uncompressed stream of video data from the CPU, and generate pixel data, and store in a frame buffer 120. Such processing can for example be performed in accordance with a refresh rate of display. An encoder 125 can compress data, for example according to a Motion Picture Expert Group (MPEG) 2 standard. Typically, a hierarchial packetizing scheme can be used in such MPEG2 System protocol. The stream from the encoder 125 can be packetized to a Packetized Elementary Stream (PES), wherein the Packetized Elementary Stream can be further packetized to a Transport Stream (TS) or a Program Stream (PS), and be transmitted from the computing unit to the monitor (not shown). The encoder 125 can encode a scheme programmable in software to detect type of format the receiving monitor side is capable of displaying. Accordingly, such monitor can be a general purpose viewing equipment, and typically need not carry a burden of reproducing Graphical Design Interface (GDI) subsystem as a part thereof, and hence can mitigate a price associated with the monitor. As such, the computing unit can perform conversion from high level semantics transformation to graphics data, which can then be forwarded to the frame buffer 120. Such frame buffer 120 can be coupled to a memory area 130, wherein the frame buffer 120 can be time-based and updated at regular intervals (e.g., 60-90 frames per second) to produce a rich animation experience. For example, similar to placing data in a frame buffer for purpose of transferring to an analog/digital converter, the subject invention can interact with the frame buffer 120, yet instead of converting digital to analog signals to drive the monitor, the subject invention supplies a compressed wireless data stream to the monitor side, which is being decoded by an associated decoder.

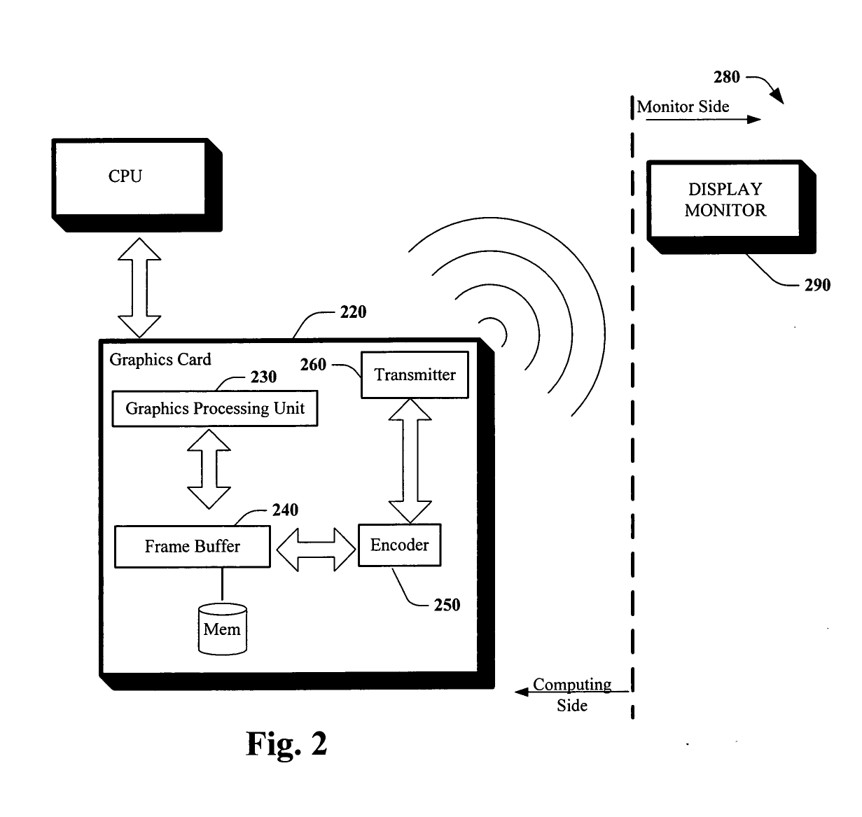

FIG. 2 illustrates a block diagram for a graphics card 220 according to one aspect of the subject invention. The graphics card 220 can include a GPU 230 that can write to a frame buffer 240 and an encoder 250 that can read from the frame buffer 240 to provide an encoding of data stream that is transmitted to a monitor side 280. For example, the encoder 250 can be an MPEG encoder. Typically, in accordance with such MPEG standards, each of the frames representing a moving picture can be classified as an I, P or B frame. An I-frame stands for an intra-coded frame, which is also called an “intra frame”. A P-frame is an abbreviation of a predictively coded frame, which is also called a “predicted frame”. And a B-frame means a bidirectionally coded frame, which is also called a “bidirectionally predicted frame”. The mode of coding applicable to a picture, or the type of macroblocks included in the picture, can be determined depending on the type of the picture, for example, I, P or B. In particular, macroblocks in an I-frame can be processed in an intra-frame coding mode. Macroblocks in a P-frame can be coded in an intra-frame coding mode or in a forward inter-frame predictive coding mode with or without motion compensation. One of such coding modes can be selected for the P-frame to minimize a prediction error. And macroblocks in a B-frame can be coded in an intra-frame coding mode or in a forward, backward or bidirectional inter-frame predictive coding mode. As for the B-frame, one of these coding modes is also selected to minimize a prediction error. It should be noted that the predictive coding modes for B-frames all require motion compensation. Each macroblock can be composed of 16 times 16 pixels. A transmitter component 260 can be operatively connected to the encoder 250 for wireless transmittal of a data stream so encoded. Moreover, data being sent to the monitor side 280 can be controlled, for example, the subject invention can wirelessly transmit images for a particular window, or images of the entire desk top, rather than employing GDI commands. The wireless data transfer can occur in a variety of formats; such as Ultra Wide Band (UWB), Internet Protocol (IP) data packets, and the like. On the monitor side 280 a receiver component (not shown) can receive the transmitted data stream, for decoding via a decoder and transfer to the monitor. The receiver and/or decoder can be integrated with the monitor 290 or alternatively exist as separate components that are operatively connected to the monitor. As such, the monitor 290 can be a general purpose viewing equipment, and typically need not carry a burden of reproducing Graphical Design Interface (GDI) subsystem as a part thereof, and hence can mitigate a price increase associated with the monitor. For example, according to an aspect of the invention a simple decoder as part of the monitor can decode a data stream transmitted thereto via the transmitter of the graphics card 220.

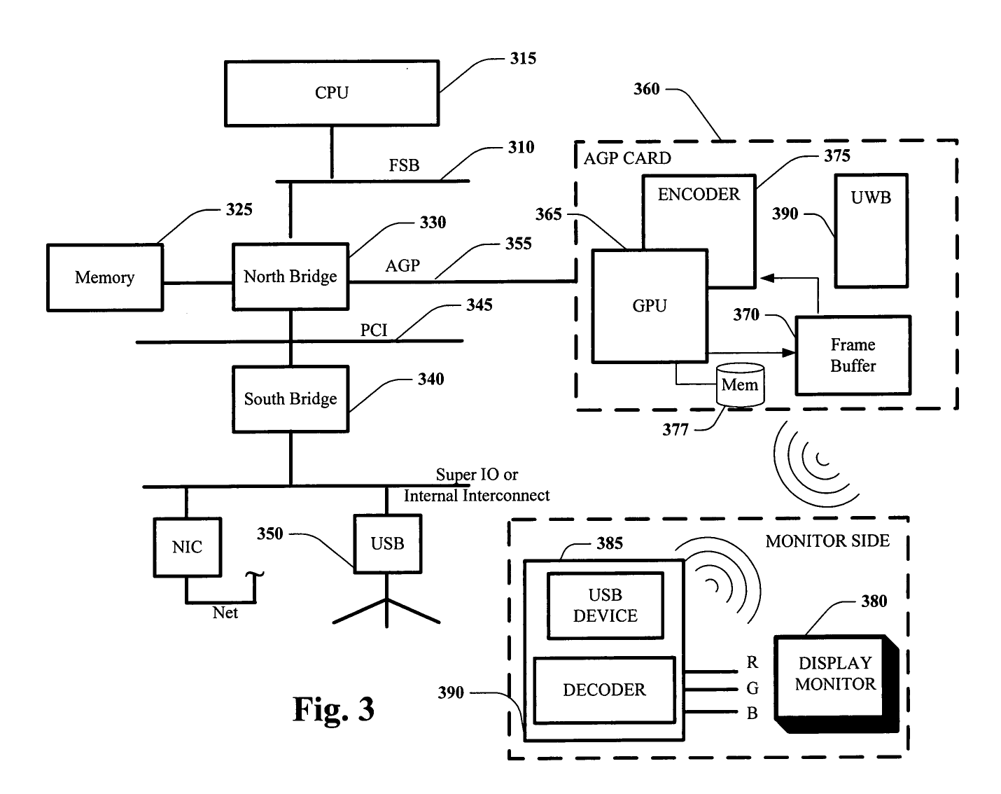

Referring now to FIG. 3 a general architecture for a computer that incorporates an aspect of the subject invention is illustrated. A Front Side Bus (FSB) 310 ranging from speeds 400 MHz, and up, can connect the CPU 315 with the main memory 325 for fetching commands and data transfer. The FSB 310 speed can generally be set either using the system BIOS or with jumpers located on the computer motherboard. In addition, as illustrated in the Northbridge/Southbridge 330, 340 chipset architecture designs of FIG. 3, the Northbridge 330 can function as the chip or chips that connect the CPU 315 to a memory 325, the PCI bus 345, and Accelerated Graphics Port (AGP) 355 activities. In general, the AGP 355 can be based on PCI, yet is designed especially for the throughput demands of 3-D graphics. For example, rather than using the PCI bus for graphics data, AGP introduces a dedicated point-to-point channel so that the graphics controller can directly access main memory. The AGP channel can be 32 bits wide and run at 66 MHz. Such can translate into a total bandwidth of 266 MBps, (as opposed to the PCI bandwidth of 133 MBps.) In addition, AGP can also support two optional faster modes, with throughputs of 533 MBps and 1.07 GBps, and AGP can allow 3-D textures to be stored in main memory rather than video memory.

Moreover, typically, the Northbridge chip 330, can be one of two chips that control the functions of the chipset. As illustrated, the other can be the Southbridge (SB) 340. In general, the Southbridge 340 is the chip that controls all of the computers I/O functions, such as Universal Serial Bus, audio, serial, the system BIOS, the ISA bus, the interrupt controller and the Integrated Drive Electronics (IDE) channels. In other words, all of the functions of a processor except, in general, memory, PCI and AGP.

In accordance with an aspect of the subject invention, and as illustrated in FIG. 3, the graphics card 360 coupled to the AGP channel 355 can include a frame buffer 370 with a memory area 377. As explained earlier, the frame buffer 370 can be time-based and updated at regular intervals (e.g., 60-90 frames per second) to produce a rich animation experience. The GPU 365 can receive an uncompressed stream of video data from the CPU 315, and generate pixel data and store in the frame buffer 370. Moreover, as for the interaction of the GPU 365 with the fame buffer 370, similar to placing data in a frame buffer for purpose of transferring to an analog/digital converter, the subject invention can interact with the frame buffer 370, yet instead of converting digital to analog signals to drive the monitor, the subject invention supplies a compressed wireless data stream to the monitor 380, which can be received and decoded by the dongle 385. Hence, the GPU 365 can perform conversion from high level semantics transformation to graphics data, which can then be forwarded to the frame buffer 370. The graphics card 360 can include an encoder 375 that can compress data, for example according to a Motion Picture Expert Group (MPEG) 2 standard. Also, the encoder 375 can encode a scheme programmable in software to detect type of format the receiving monitor 380 is capable of displaying. Accordingly, the monitor 380 can be a general purpose viewing equipment, and typically need not carry a burden of reproducing Graphical Design Interface (GDI) subsystem as a part thereof, thus mitigating a price increase associated with the monitor. The processing can also be performed in accordance with a refresh rate of display.

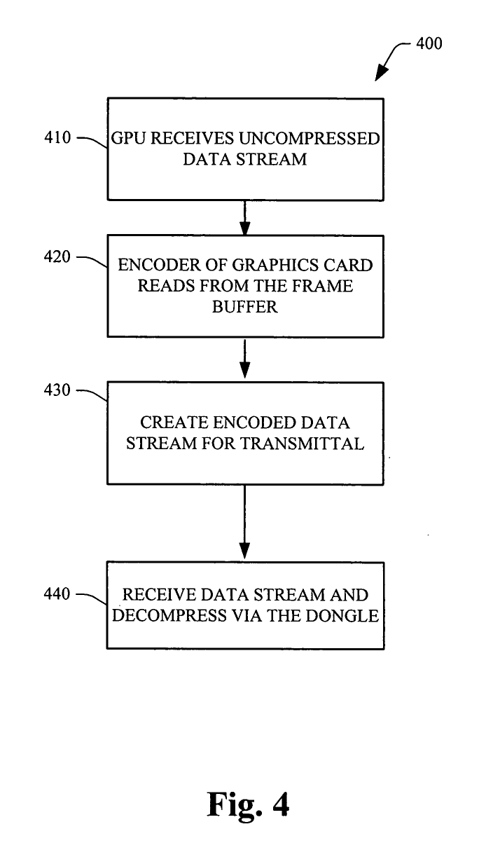

FIG. 4 illustrates a methodology 400 of wireless display in accordance with an aspect of the subject invention. Initially, and at 410 the GPU can receive an uncompressed stream of video data from the CPU, and can generate pixel data to store in the frame buffer. Subsequently, and at 420 the encoder of the graphics card can read from the frame buffer and provide an encoded data stream (e.g., light weight encoding, MPEG4-style encoders, Wavelet-style encoders, and the like) at 430 for transmission to the monitor via a wireless transmission protocol. Such encoded data stream can be transmitted via a high bandwidth, (e.g., an Ultra wide band), isochronous-friendly wireless medium. The compressed video stream can then be received and decoded by a dongle at 440, for example in from of an adapter that can receive the wireless signal upon connection to a VGA connector of the monitor.

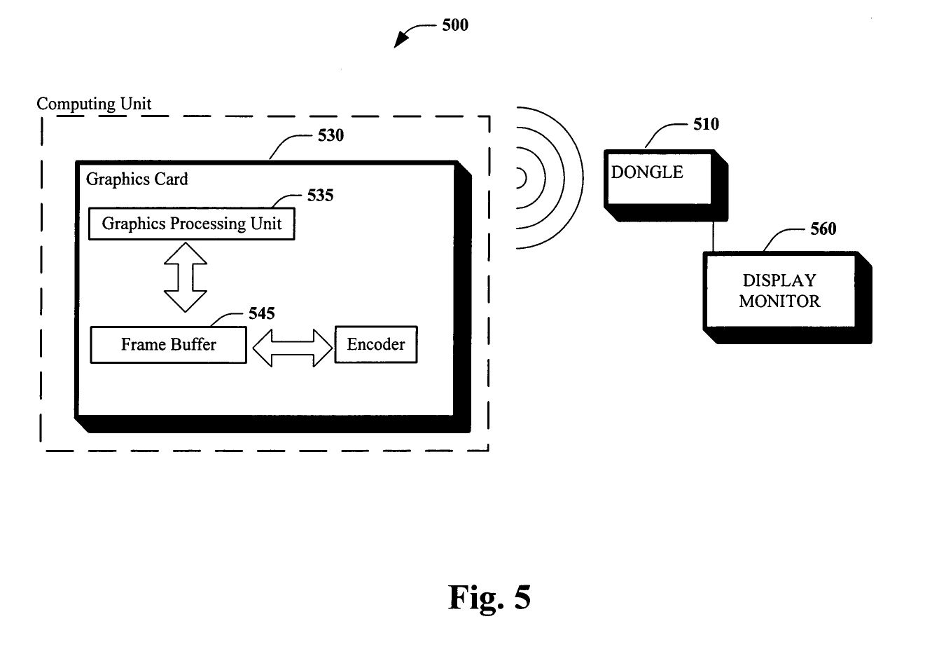

FIG. 5 illustrates a further block diagram of a system in accordance with an aspect of the subject invention. In general, to ensure security and integrity of the system 500, the subject invention can employ link layer security via secure channel protocols to secure a wireless data transfer link 520 using session keys and a certificate authority. For example, the monitor dongle 510 can first plug into the computing device by using a wired method (e.g., USB, Ethernet) to obtain a certificate and session key. Such obtained certificate and session key can then be employed to encrypt the link 520.

As explained earlier, the system includes a graphic card 530 with a Graphics Processing Unit (GPU) 535 that can be operatively connected to a Central Processing Unit (CPU-not shown). According to one aspect, the subject invention can employ the power of the GPU 535 to re-compress all or portions of the frame buffer 545 by using a video compression algorithm. For example, during a terminal services session, the GPU 535 can be controlled by system level software running on the CPU. Since the video compression can compress the frame buffer 545 directly, typically the subject invention need not employ GDI primitives to remotely render the experience. As such the computer can perform conversion from high level semantics transformation to graphics data, (which can then be forwarded to the frame buffer), and the monitor 560 can be a general purpose viewing equipment. The monitor 560 typically need not carry a burden of reproducing Graphical Design Interface (GDI) subsystem as a part thereof.

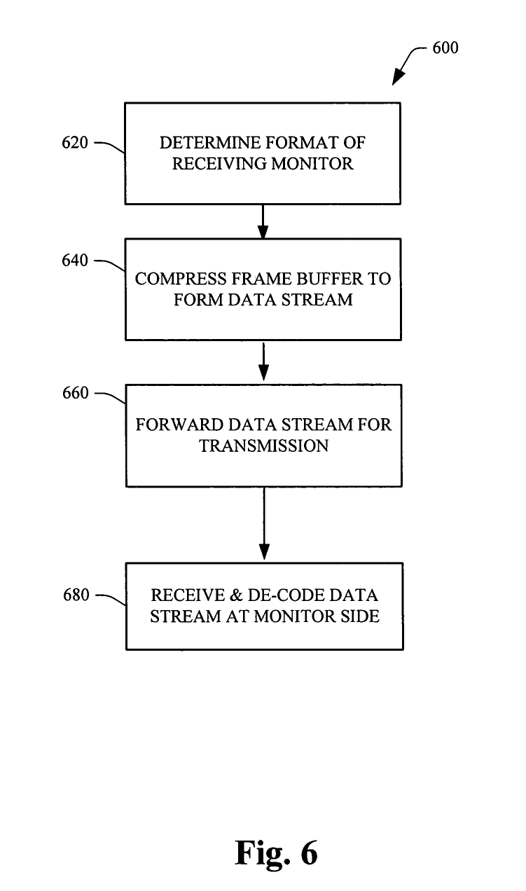

FIG. 6 illustrates a methodology 600 of wireless display in accordance with an aspect of the subject invention. Initially, and at 620 a format of display for the receiving monitor side is detected. For example, the encoder can encode a scheme programmable in software to detect type of format the receiving monitor is capable of displaying. Next, and at 640 the subject invention employs a video compression to compress the frame buffer directly, and form a data stream. Such encoded video stream can then be forwarded to a transmitter for transmission via an ultra wide band wireless system, at 660. Such compressed video stream can then be received by a receiver and decoded by a decoder, as part of, or separate from the monitor, at 680.

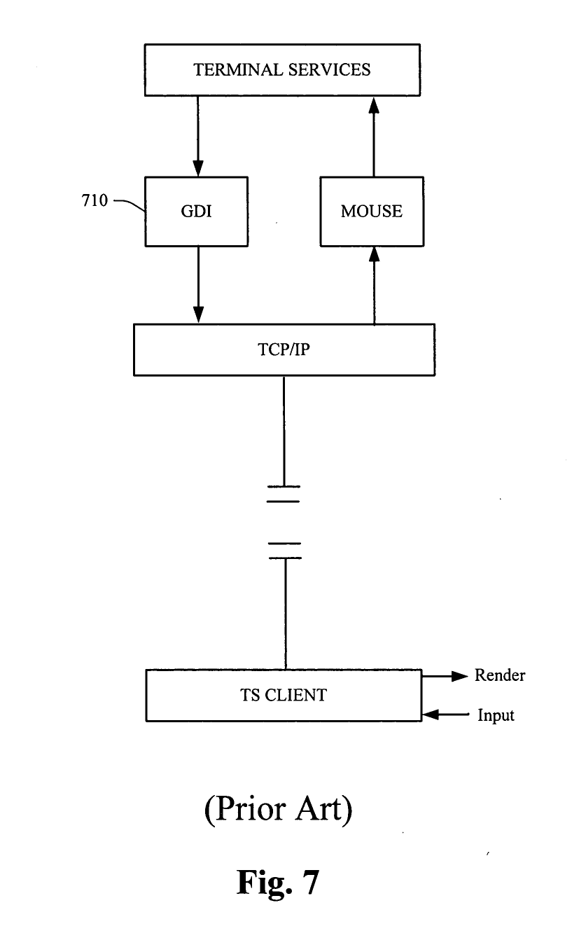

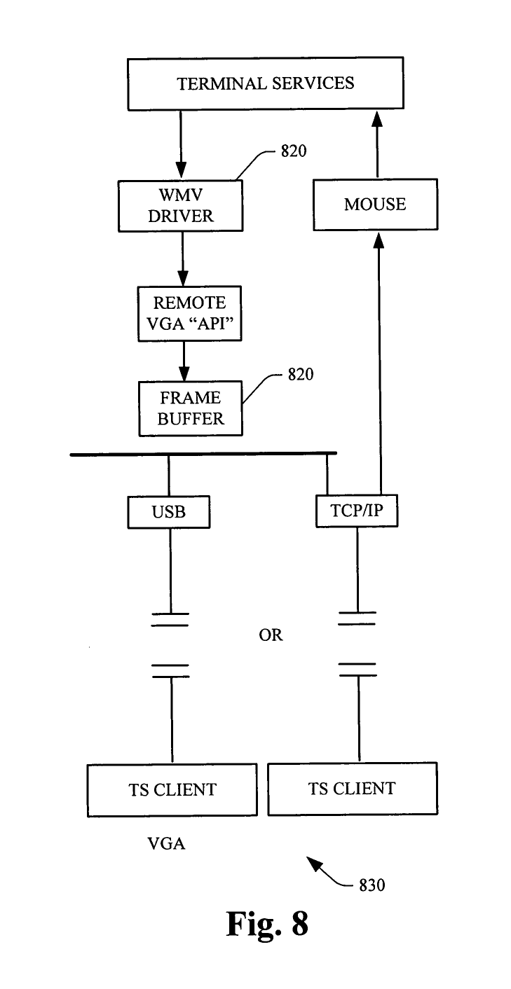

Referring now to FIG. 7 & FIG. 8, a system arrangement for a wireless monitor during establishment of a remote session and terminal services is illustrated according to conventional systems, and is compared to an aspect of the subject invention. In particular, in conventional systems of FIG. 7 the system can primarily include a Graphical Design Interface (GDI) 710 rendering and the ability to logon to computer/session. Such can replicate typically the same GDI functions that are available for the computer on the monitor. AS the graphic experience moves from a two dimensional (2D) to a three-dimensional (3D) experience, in conventional systems the “pipe line” employed for transferring the data becomes a limiting factor for a rich graphical experience. In addition, the display portion of the system, for example a monitor, can become more expensive as it typically attempts to replicate most important parts of the computer.

An aspect of the subject invention, as depicted in FIG. 8, by employing an encoder and a frame buffer 820 can create a light weight compressed video stream for transfer to the monitor. For example, the encoder can encode a scheme programmable in software to detect type of format the receiving monitor is capable of displaying. Accordingly, the monitor can be a general purpose viewing equipment, and typically need not carry a burden of reproducing Graphical Design Interface (GDI) subsystem as a part thereof, and hence can mitigate a price increase associated with the monitor. Moreover, similar to placing data in a frame buffer for purpose of transferring to an analog/digital converter, the subject invention can interact with the frame buffer, yet instead of converting digital to analog signals to drive the monitor, the subject invention supplies a compressed wireless data stream to the monitor. Such system can typically take full advantage of hardware available on the hardware of the computing device, and the Graphical Processing Unit (GPU). A simple decoder as part of the monitor can decode a data stream transferred through the UWB or TCP/IP over WiFi transmission.

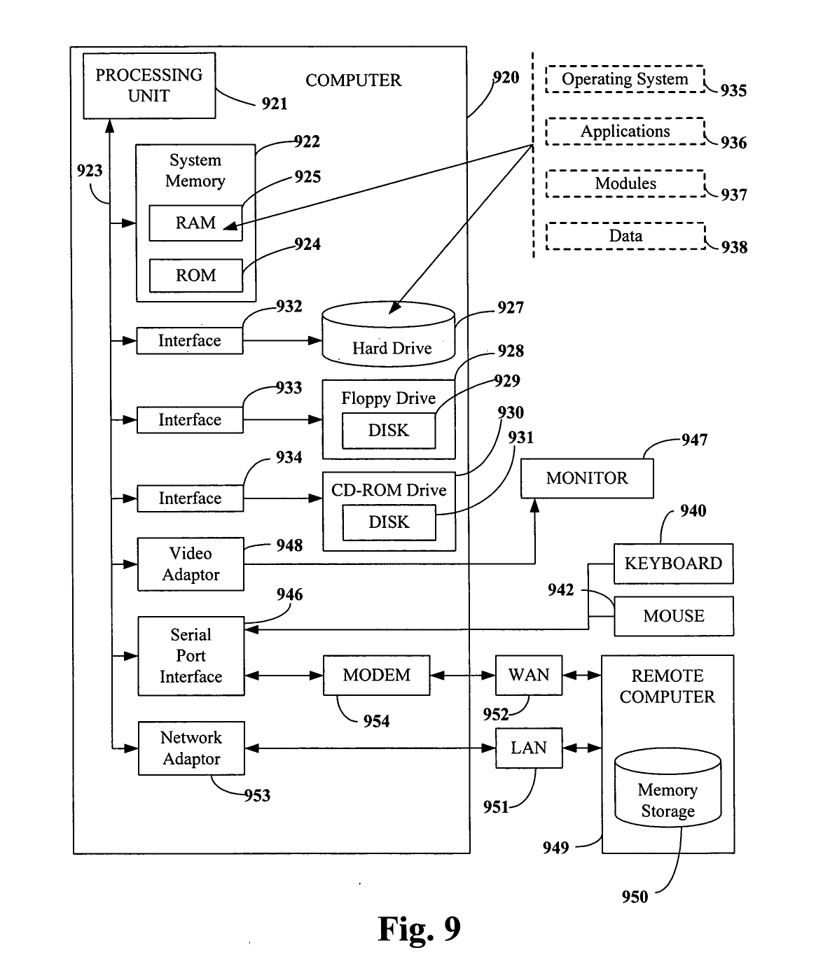

Referring now to FIG. 9, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 920, including a processing unit 921, a system memory 922, and a system bus 923 that couples various system components including the system memory to the processing unit 921. The processing unit 921 can be any of various commercially available processors. Dual microprocessors and other multi-processor architectures also can be used as the processing unit 921.

The system bus can be any of several types of bus structure including a memory bus or memory controller, a peripheral bus, and a local bus using any of a variety of commercially available bus architectures. The system memory may include read only memory (ROM) 924 and random access memory (RAM) 925. A basic input/output system (BIOS), containing the basic routines that help to transfer information between elements within the computer 920, such as during start-up, is stored in ROM 924.

The computer 920 further includes a hard disk drive 927, a magnetic disk drive 928, e.g., to read from or write to a removable disk 929, and an optical disk drive 930, e.g., for reading from or writing to a CD-ROM disk 931 or to read from or write to other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide nonvolatile storage of data, data structures, computer-executable instructions, etc. for the computer 920. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention.

A number of program modules can be stored in the drives and RAM 925, including an operating system 935, one or more application programs 936, other program modules 937, and program data 938. The operating system 935 in the illustrated computer can be substantially any commercially available operating system.

A user can enter commands and information into the computer 920 through a keyboard 940 and a pointing device, such as a mouse 942. Other input devices (not shown) can include a microphone, a joystick, a game pad, a satellite dish, a scanner, or the like. These and other input devices are often connected to the processing unit 921 through a serial port interface 946 that is coupled to the system bus, but may be connected by other interfaces, such as a parallel port, a game port or a universal serial bus (USB). A monitor 947 or other type of display device is also connected to the system bus 923 via an interface, such as a video adapter 948, and be employing the various aspects of the invention as described in detail supra. In addition to the monitor, computers typically include other peripheral output devices (not shown), such as speakers and printers. The power of the monitor can be supplied via a fuel cell and/or battery associated therewith.

The computer 920 can operate in a networked environment using logical connections to one or more remote computers, such as a remote computer 949. The remote computer 949 may be a workstation, a server computer, a router, a peer device or other common network node, and typically includes many or all of the elements described relative to the computer 920, although only a memory storage device 950 is illustrated in FIG. 9. The logical connections depicted in FIG. 9 may include a local area network (LAN) 951 and a wide area network (WAN) 952. Such networking environments are commonplace in offices, enterprise-wide computer networks, Intranets and the Internet.

When employed in a LAN networking environment, the computer 920 can be connected to the local network 951 through a network interface or adapter 953. When utilized in a WAN networking environment, the computer 920 generally can include a modem 954, and/or is connected to a communications server on the LAN, and/or has other means for establishing communications over the wide area network 952, such as the Internet. The modem 954, which can be internal or external, can be connected to the system bus 923 via the serial port interface 946. In a networked environment, program modules depicted relative to the computer 920, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 920, unless otherwise indicated. Such acts and operations are sometimes referred to as being computer-executed. It will be appreciated that the acts and symbolically represented operations include the manipulation by the processing unit 921 of electrical signals representing data bits which causes a resulting transformation or reduction of the electrical signal representation, and the maintenance of data bits at memory locations in the memory system (including the system memory 922, hard drive 927, floppy disks 928, and CD-ROM 931) to thereby reconfigure or otherwise alter the computer system's operation, as well as other processing of signals. The memory locations wherein such data bits are maintained are physical locations that have particular electrical, magnetic, or optical properties corresponding to the data bits.

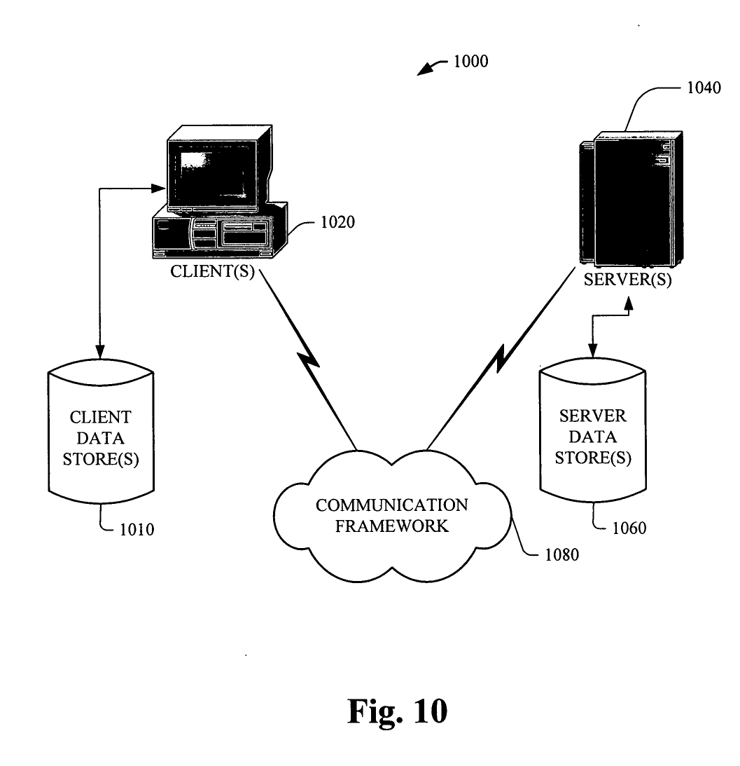

Referring now to FIG. 10, a client-server system 1000 that can employ various aspects of the subject invention for wireless display on the client or server side, is illustrated. The client(s) 1020 can be hardware and/or software (e.g., threads, processes, computing devices). The system 1000 also includes one or more server(s) 1040. The server(s) 1040 can also be hardware and/or software (e.g., threads, processes, computing devices). The client 1020 and the server 1040 can communicate, in the form of data packets transmitted according to the subject invention, between two or more computer processes. As illustrated, the system 1000 includes a communication framework 1080 that can facilitate communications between the client(s) 1020 and the server(s) 1040, and/or the respective display monitors. The client(s) 1020 is operationally connected to one or more client data store(s) 1010 that can store information local to the client(s) 1020. Moreover, client 1020 can access and update databases 1060 located on a server computer 1040 running a server process. In one aspect of the subject invention, the communication frame work 1080 can be the internet, with the client process being a Web browser and the server process being a Web server.

As such, a typical client 1020 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 1040 can be university or corporate mainframe computers, or dedicated workstations, and the like.

Moreover, although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates wireless display comprising:
a graphics card with an encoder that reads data from a buffer and encodes the data to form a data stream forwarded to a transmitter; and
the transmitter that wirelessly transmits the data stream to a decoder operatively connected to a monitor.

2. The system of claim 1 further comprising a Graphical Processing Unit that generates pixel data that is stored in the frame buffer.

3. The system of claim 2 further comprising a Central Processing Unit that forwards an uncompressed stream of video data to the Graphical Processing Unit.

4. The system of claim 1 the transmitter transmits data in at least one of an Ultra Wide Band and an Internet Protocol.

5. The system of claim 1, the encoder encodes a scheme programmable in software to detect the type of format the monitor displays.

6. The system of claim 1, the decoder is part of the monitor.

7. The system of claim 1, the frame buffer is uploaded at regular intervals.

8. The system of claim 1, the encoder employs a Motion Picture Expert Group Standard.

9. The system of claim 1, the transmitter supplies a compressed wireless data stream to the monitor.

10. A method of wireless display comprising:
reading data from a frame buffer via an encoder at a computing side of a wireless display system; and
encoding data stored in the frame buffer to form a data stream for wireless transmittal to a monitor side of the wireless display system.

11. The method of claim 10 further comprising converting high level semantics to graphical data via a Graphical Processing Unit at the computing side of the wireless display system.

12. The method of claim 10 further comprising forwarding an uncompressed stream of video data to the Graphical Processing Unit via a Central Processing Unit.

13. The method of claim 12 further comprising controlling the Graphical Processing Unit by system level software running on the Central Processing Unit during a terminal services session.

14. The method of claim 10 further comprising transmitting data to the monitor side by employing at least one of an Ultra Wide Band and an Internet Protocol.

15. The method of claim 14 further comprising detecting a display format of the monitor side.

16. The method of claim 14, further comprising encoding a scheme programmable in software to detect the display format of the monitor side.

17. The method of claim 14, further comprising receiving the data stream via a dongle of the monitor side.

18. The method of claim 17 further comprising decoding the data stream via an encoder associated with the dongle.

19. The method of claim 17 further comprising uploading the frame buffer at regular intervals.

20. A system for wireless display comprising:
means for generating pixel data to be stored in a buffer means;
means for encoding the pixel data in to a data stream; and
means for transmitting the data stream to a monitor side.
